(19) United States
(12) Patent Application Publication
(10) Pub. No.: US 2010/0134630 A1
(43) Pub. Date: Jun. 3, 2010

(54) FREQUENCY AND SPECTRAL DOMAIN SOLUTIONS FOR PREVENTION OF VIDEO RECORDING

(76) Inventor: Yongshik Yoon, Valencia, CA (US)

Correspondence Address: Robert D. Shedd, Patent Operations;THOMSON Licensing LLC, P.O. Box 5312, Princeton, NJ, 08543-5312, US

(21) Appl. No.: 12/452,251

(22) PCT Filed: Jun. 27, 2007
(86) PCT No.: PCT/US07/14965

§ 371 Date: Dec. 21, 2009

(51) Int. Cl. H04N 5/33; H04N 9/31

(52) U.S. Cl. 348/164; 348/744; 348/E05.09; 348/E09.025

(57) ABSTRACT

A projection system has a projector having a varying frame rate during the course of operation. The projector having warning message frames in between actual video frames. The warning frames are not detectable to humans. A light source which emits infrared light and ultraviolet light at wavelengths and intensities detectable by movie cameras (e.g., camcorders) and undetectable to humans.

### FIELD OF THE INVENTION

The invention relates to a video recording prevention system. In particular, the invention relates to the combination of frequency and spectral domain solutions for the prevention of illicit video recording.

### BACKGROUND OF THE INVENTION

The advent of highly portable camcorders has enabled moviegoers to wrongfully and surreptitiously capture the video content of movies displayed in theaters. In an effort to combat such activities, some theaters have incorporated systems for preventing the recording of movie content or degrading video captured by camcorders. The approaches have varied, but each has attempted to exploit the differences between the optical technology of camcorders and the human optical system.

To degrade captured video, some theaters have employed the use of ultraviolet or infrared light, both of which are invisible to the human optical system but detectable and recordable by typical camcorders. Because ultraviolet light (UV) or infrared light (IR) can conceivably be detected by those seeking to record movie content and such people could conceivably implement spectral filters on their camcorders, the use of UV and IR is discouraged.

Some theaters have attempted to prevent video recording by the use of frequency modulation which may deliver, for example, a copyright infringement warning detectable and recordable by typical camcorders as part of video degradation. Unfortunately, the frequency modulation method is discouraged because it is dependent on a camcorder's shutter mechanism and introduces a flicker visible to the human optical system which results in an unpleasant viewing experience for the audience.

It is therefore desirable to develop an improved video recording prevention system.

### SUMMARY OF THE INVENTION

The present invention is directed to an anti-recording apparatus having the combination of a frequency modulation domain component and spectral domain component which are detectable by a recording device.

### BRIEF DESCRIPTION OF THE DRAWINGS

FIG. 1 is a schematic illustration of a theatre.

FIG. 2 is a side view of the implementation of the spectral domain component according to the invention.

FIG. 3 is top view of the implementation of the frequency modulation domain component and spectral domain component according to the invention.

FIG. 4 is front view of the implementation of the frequency modulation domain component and spectral domain component according to the invention.

### DETAILED DESCRIPTION OF THE INVENTION

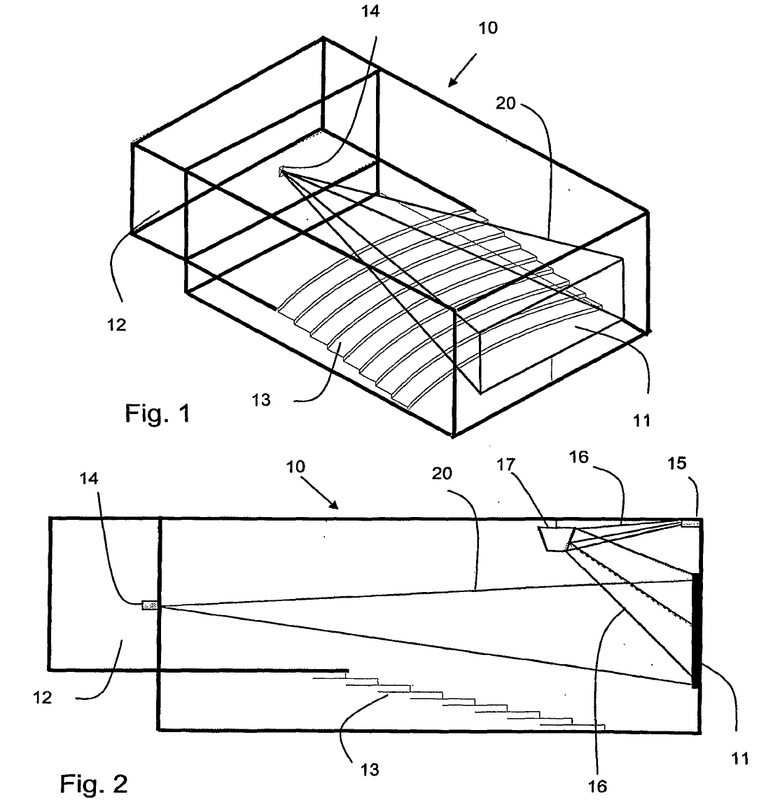

FIG. 1 shows the layout of a theatre or cinema 10, which can employ anti-piracy utilities such as frequency domain solutions which will now be described. As shown in FIG. 1, the theatre 10 employing the invention comprises of a projection room 12, viewer seats 13 in steps, and a projector 14 which projects motion picture images 20 on a screen 11. From here, the use of software manipulation in the projector 14 enables the use of the frequency domain solution. The frequency domain solution of the invention utilizes the different inherent sensitivities between the human visual system and a camcorder which are, respectively an integration system and a sampling sampling. In light of these differences, warning message frames or copyright infringement message frames can be included in between the movie frames or actual video frames on the screen such that the moviegoer will not perceive these messages. On the other hand, these messages will be captured by the movie camera or camcorder, as long as the shutter speed is set at a sufficiently fast speed. However, as the infringer slows the shutter speed to avoid warning message frames, the camcorder's propensity to record blurred moving images increases.

The frequency domain solution of the invention can also take advantage of aliasing artifacts that a camcorder will experience when operated under certain conditions. With regards to alias artifacts, it is important to understand that the Shannon theorem suggests that the camcorder sampling rate should be at least twice the rate of a film rate to avoid the possibility of an alias effect. As such, a key feature of the invention is to use greater frame rates. Because DLP® (digital light projection) technology can easily provide frame rates of up to 144 Hz in the motion picture images 20, the use of such frame rates can be readily implemented in theatres to increase the likelihood of aliasing in camcorders. Camcorders typically sample at about 60 Hz. In a preferred embodiment, the frame rate is at least 144 Hz, thereby making this frequency solution more effective at causing aliasing for camcorders having higher sample rate capability. However, frame rates of 100 Hz or greater are effective.

The advantage of the frequency domain is that there is no extra hardware required and this component is highly effective at high shutter speeds, because camcorders will capture warning message frames or copyright infringement message frames. Further, if the shutter speed is slow, (e.g. 1/15 sec or 1/60), the picture quality to the viewer of the camcorder recording will likely be degraded, even if the warning message frames or copyright infringement message frames are not captured by the camcorder. It is important to point out that the human visual system is such that as frame rates go under approximately 50 Hz, individual frames become detectable to humans as jitter.

Shutter speed (speed of an opening or capture time duration) of a camcorder dictates the amount of light that can be admitted to a CCD. High speeds admit or collect less light and low speeds admit or collect more light. Low speeds, however, may cause blurring if fast moving objects are recorded. As such, if an infringer is selecting shutter speeds to avoid blur or avoid warning message frames, the infringer may not have the camcorder optimized for proper image brightness or contrast.

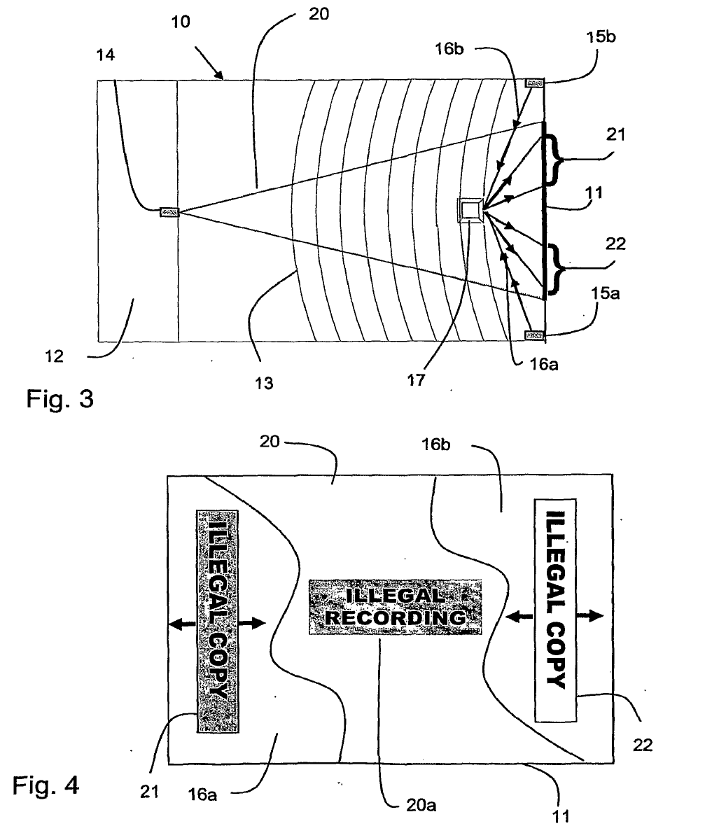

FIG. 2 shows a side view of a theatre or cinema 10, which can employ frequency domain solutions in combination with the spectral domain solution, which will now be described. As shown in FIG. 2, the theatre 10 comprises a projection room 12, viewer seats 13 in steps, projector 14, and screen 11. The spectrum domain solution requires hardware components. A first component is at least one UV source, which can be UV lasers, and/or at least one IR source, which can be IR lasers. The source or sources which make up the IR source 15b and/or UV source 15a is shown in FIG. 3. FIG. 2 shows the sources as reference numeral 15. FIG. 2 shows just a single component for the light source to illustrate an embodiment where there is one device that produces both IR and UV light or other embodiments where the source or sources can be positioned at different locations in the theatre 10 which includes locations along the top of the front of the theatre 10. The invention further includes an electronically controlled rotating mirror (or polygon mirror or functional equivalent) 17 attached to the ceiling of the theatre 10 which is used to collectively Project the IR and/or UV light 16 toward the screen 11. The UV and/or IR light 16 incident on the screen then propagates into the theatre for potential illicit video recorders to capture. In a preferred embodiment, alphanumeric characters can be inscribed in the mirror which can contain a warning message that is detectable by camcorders, but not visible to the moviegoers. In such an embodiment, the entire screen 11 can be irradiated with IR or UV light and the alphanumeric characters can form a pattern of absence or lack of the IR or UV light.

FIG. 3 shows a top view of the combination of the methodologies in a presently preferred embodiment. The frequency modulation domain component is captured in the motion picture images 20 being projected onto screen 11. The spectral domain component according to the invention utilizes the rotating mirror 17 in concert with a distinct UV source 15a and a distinct IR source 15b positioned at opposite sides of the front wall of the theatre 10. The UV light 16a and IR light 16b are shown propagating from opposite sides of the front wall. The rotating mirror reflects the UV light 16a and IR light 16b toward the screen 11. Regions 21 and 22 contain images associated with the UV light 16a and IR light 16b, respectively, which can degrade and deter video recording.

FIG. 4 shows the front view of the screen in FIG. 3 according to another. The UV light 16a and IR light 16b are projected on the entire screen 11. The collection of alphanumerical characters shown in the region 21 are portions of the screen 11 not irradiated with UV light 16a. The collection of alphanumerical characters shown in the region 22 are portions of the screen 11 not irradiated with IR light 16b. In such an embodiment the regions 21, 22 scan back-and-forth in opposite directions to one another. These regions 21, 22 contain warning or copyright messages or other objectionable material that will be invisible to the moviegoer, but perceptible to the camcorder. An alternative embodiment includes only a portion of the screen receiving the UV light 16a and IR light 16b

Further, the embodiment in FIG. 4 includes the frequency domain solution wherein some frames of the motion picture images 20 contain frames with a warning message or copyright infringement message 20a, which will be imperceptible to the moviegoer, but perceptible to a camcorder, provided that a sufficiently fast shutter speed is used. As long as such frequency domain solution is based on software, the warning message could be manipulated to any shape.

As a result, a video recorder or camcorder used in this environment described in FIG. 4 would be subjected to (1) warning message frames (such as the infringement message 20a in FIG. 4) which is in between the movie frames or actual video frames and (2) the consistent background of IR and UV light that has message regions 21, 22 scanning across the screen.

Regarding the spectral domain solution, it takes advantage of the high sensitivity in near IR region (up to 1 micron=1000 nm) in silicon cells in camcorders. This IR is invisible to viewers, but capturable by recording equipment. Although the sensitivity in UV is relatively low in comparison with that in IR, silicon cells surprising still capture UV light. Further, it is important to note that the spectral component is effective regardless of shutter speed. Slow shutter speeds of the camcorder will tend to lead to whole pictures being washed out. Camcorders which use high shutter speeds will still tend to perceive the alphanumeric characters appearing as warning messages in the regions 21, 22 when such messages are inscribed on the mirror 17; however, the regions 21, 22 will not be visible to moviegoers.

The implementation of the combination of the frequency and spectral domain solutions turns out to be effective because each solution compensates for the weakness of the other solution. The weakness of the spectral component is that it can be defeated by stacking filters of multiple wavelength domains in front of the camcorder; however, the use of such filters reduces transmission of visible light. With light transmission low, the pirate would have to slow the shutter speed, which in turn degrades picture quality in the form of blurred images. The weakness of the frequency domain component is that it can be defeated with slow shutter speed; however, when the shutter speed is low, the camcorder is more susceptible the UV and IR spectral domain solution.

In sum, the combination of frequency domain and spectrum domain methodologies makes it significantly more difficult for copyright infringers to illicitly record motion pictures in theatres.

The foregoing illustrates some of the possibilities for practicing the invention. Many other embodiments are possible within the scope and spirit of the invention. For example, although camcorder is repeatedly mentioned, the invention is intended to be applicable to other types of video cameras. Further, other embodiments can include varying the frame rate of the projector at rates not perceptible to the moviegoer during the course of operation, which has the intended result of confusing the infringer by making it such that at optimized conditions in terms of shutter speed or sampling rates for defeating the frequency domain components will change during the course of a movie, which means that the movie frame rate can vary during the course of showing a movie. Further, the intensities of the UV light 16a and IR light 16b can vary collectively, independently, or randomly (i.e. they can increase and decrease together or one can increase while the other decreases or does not vary) to make it more difficult for a pirate find and use correct filters for the different intensity conditions. Another aspect of the invention is that a warning message frame is intended to include some frame having some content that does not necessarily comprise alphanumeric characters but would be objectionable to a viewer if seen by the viewer while viewing actual video frames of a movie.

1. A projection system comprising:
a projector having a varying frame rate during the course of operation; and,
at least one light source projecting light on a screen of a wavelength detectable by movie cameras and undetectable to humans.

2. The projection system of claim 1 wherein the at least one light source projects infrared light.

3. The projection system of claim 1 wherein the at least one light source projects ultraviolet light.

4. The projection system of claim 1 wherein the at least one light source projects ultraviolet light and infrared light.

5. The projection system of claim 1 wherein the at least one light source projects infrared light, at least one region of infrared light on the screen providing a warning message formed by some lack of infrared light.

6. The projection system of claim 1 wherein the at least one light source projects ultraviolet light, at least one region of ultraviolet light on the screen providing a warning message formed by some lack of infrared light.

7. The projection system of claim 3 wherein the at least one light source projects infrared light, at least one region of infrared light on the screen providing a warning message formed by some lack of infrared light.

8. The projection system of claim 2 wherein the at least one light source projects ultraviolet light, at least one region of ultraviolet light on the screen providing a warning message formed by some lack of ultraviolet light.

9. The projection system of claim 5 wherein the at least one light source projects ultraviolet light, at least one region of ultraviolet light providing a warning message formed by some lack of infrared light.

10. The projection system of claim 1 wherein the at least one mirror comprises an inscription which forms at least one warning message on the screen by lack of the light in at least one region of the light.

11. The projection system of claim 10 wherein the mirror scans the at least one warning message across the screen.

12. The projection system comprising:
a projector having a frame rate of 100 Hz or greater; and,
at least one light source projecting light on a screen of a wavelength detectable by movie cameras and undetectable to humans.

13. The projection system of claim 12 wherein the at least one light source projects infrared light.

14. The projection system of claim 12 wherein the at least one light source projects ultraviolet light.

15. The projection system of claim 12 wherein the at least one light source projects ultraviolet light and infrared light.

16. The projection system of claim 12 wherein the at least one light source projects infrared light, at least one region of infrared light on the screen providing a warning message formed by some lack of infrared light.

17. The projection system of claim 12 wherein the at least one light source projects ultraviolet light, at least one region of ultraviolet light on the screen providing a warning message formed by some lack of infrared light.

18. The projection system of claim 14 wherein the at least one light source projects infrared light, at least one region of infrared light on the screen providing a warning message formed by some lack of infrared light.

19. The projection system of claim 13 wherein the at least one light source projects ultraviolet light, at least one region of ultraviolet light providing a warning message formed by some lack of ultraviolet light.

20. The projection system of claim 12 wherein the at least one mirror comprises an inscription which forms at least one warning message on the screen by lack of the light in at least one region of the light.

21. The projection system of claim 20 wherein the mirror scans the at least one warning message across the screen.

22. The projection system of claim 12 wherein the frame rate varies.

23. The projection system of claim 22 wherein the at least one light source projects infrared light or ultraviolet light or both.
